(19) United States
(12) Patent Application Publication
(10) Pub. No.: US 2007/0282601 A1
(43) Pub. Date: Dec. 6, 2007

(54) Packet loss concealment for a conjugate structure algebraic code excited linear prediction decoder

(75) Inventor: Dunling Li, Rockville, MD (US)

Correspondence Address: TEXAS INSTRUMENTS INCORPORATED, P O BOX 655474, M/S 3999, DALLAS, TX, 75265, US

(73) Assignee: Texas Instruments Inc.

(21) Appl. No.: 11/446,102

(22) Filed: Jun. 2, 2006

(51) Int. Cl. G10L 11/04

(52) U.S. Cl. 704/207

(57) ABSTRACT

A method to improve packet loss concealment for generation of a synthetic speech signal in a algebraic code excited linear prediction decoder for a voice over packet network. One method improves features for coding gains in the decoder and for post-filtering of the signals. An alternative method uses a classification method for the signal based on the bitstream in the decoder.

### CROSS-REFERENCE TO RELATED APPLICATIONS

None

### FIELD OF THE INVENTION

The present invention relates generally improving the generation of a synthetic speech signal for packet loss concealment in an algebraic code excited linear prediction decoder.

### BACKGROUND OF THE INVENTION

In typical telecommunications systems, voice calls and data are transmitted by carriers from one network to another network. Networks for transmitting voice calls include packet-switched networks transmitting calls using voice over Internet Protocols (VoIP), circuit-switched networks like the public switched telephone network (PSTN), asynchronous transfer mode (ATM) networks, etc. Recently, voice over packet (VOP) networks are becoming more widely deployed. Many incumbent local exchange and long-distance service providers use VoIP technology in the backhaul of their networks without the end user being aware that VoIP is involved.

In a packet network, a message to be sent is divided into separate blocks of data packets that are the same or variable lengths. The packets are transmitted over a packet network and can pass through multiple servers or routers. The packets are then reassembled at a receiver before the payload, or data within the packets, is extracted and reassembled for use by the receiver's computer. To ensure the proper transmission and re-assembly of the data at the receiving end, the packets contain a header which is appended to each packet and contains control data and sequence verification data so that each packet is counted and re-assembled in a proper order. A variety of protocols are used for the transmission of packets through a network. Over the Internet and many local packet-switched networks the Transport Control Protocol/Internet Protocol (TCP/UDP/IP) suite of protocols and RTP/RTP-XR are used to manage transmission of packets.

An example of a multimedia network capable of transmitting a VOIP call or real-time video is illustrated in FIG. 1. The diagram illustrates a network 10 that could include managed LANs and WLANs accessing the Internet or other Broadband Network 12 such as an packet network with IP protocols, Asynchronous Transfer Mode (ATM), frame relay, or Ethernet. Broadband network 12 includes many comments that are connected with devices generally known as “nodes.” Nodes include switches, routers, access points, servers, and end-points such as user's computers and telephones. The network 10 includes a media gateway 20 connected between broadband network 12 and IP phone 18. On the other end, wireless access point (AP) 22 is connected between broadband network 12 and wireless IP phone 24. A voice over IP call may be placed between IP phone 18 and Wireless IP phone (WIPP) 24 using appropriate software and hardware components. In this call, voice signals and associated control packet data are sent in a real-time media stream between IP phone 18 and phone 24.

In a packet-switched network 10, a packet of data often traverses several network nodes as it goes across the network in “hops.” Each packet has a header that contains destination address information for the entire packet. Since each packet contains a destination address, they may travel independent of one another and occasionally become delayed or misdirected from the primary data stream. If delayed, the packets may arrive out of order. The packets are not only merely delayed relative to the source, but also have delay jitter. Delay jitter is variability in packet delay, or variation in timing of packets relative to each other due to buffering within nodes in the same routing path, and differing delays and/or numbers of hops in different routing paths. Packets may even be actually lost and never reach their destination.

Voice over Internet Protocol (VOIP) protocols are sensitive to delay jitter to an extent qualitatively more important than for text data files for example. Delay jitter produces interruptions, clicks, pops, hisses and blurring of the sound and/or images as perceived by the user, unless the delay jitter problem can be ameliorated or obviated. Packets that are not literally lost, but are substantially delayed when received, may have to be discarded at the destination nonetheless because they have lost their usefulness at the receiving end. Thus, packets that are discarded, as well as those that are literally lost are all called “lost packets.”

The user can rarely tolerate as much as half a second (500 milliseconds) of delay. For real-time communication some solution to the problem of packet loss is imperative, and the packet loss problem is exacerbated in heavily-loaded packet networks. Also, even a lightly-loaded packet network with a packet loss ration of 0.1% perhaps, still requires some mechanism to deal with the circumstances of lost packets.

Due to packet loss in a packet-switched network employing speech encoders and decoders, a speech decoder may either fail to receive a frame or receive a frame having a significant number of missing bits. In either case, the speech decoder is presented with the same essential problem—the need to synthesize speech despite the loss of compressed speech information. Both “frame erasure” and “packet loss” concern a communication channel or network problem that causes the loss of the transmitted bits.

One standard recommendation to address this problem is the International Telecommunication Union (ITU) Recommendation G.729 “Coding of Speech at 8 kbit/s Using Conjugate-Structure Algebraic-Code-Excited Linear-Prediction (CS-ACELP).” The linear prediction (LP) digital speech coding compression method models the vocal tracts as a time-varying filter and time-varying excitation of the filter to mimic human speech. The sampling rate is typically 8 kHz (same as the public switched telephone network (PSTN) sampling for digital transmission); and the number of samples in a frame is often 80 or 160, corresponding to 10 ms or 20 ms frames. The LP compression approach basically only transmits/stores updates for quantized filter coefficients, the quantized residual (waveform or parameters such as pitch), and the quantized gain. A receiver regenerates the speech with the same perceptual characteristics as the input speech. Periodic updating of the quantized items requires fewer bits than direct representation of the speech signal, so a reasonable LP coder can operate at bits rates as low as 2-3 kbs (kilobits per second).

The ITU G.729 standard uses 8 kbs with LP analysis and codebook excitation (CELP) to compress voiceband speech and has performance comparable to that of the 32 kbs ADPCM in the G.726 standard. In particular, G.729 uses frames of 10 ms length divided into two 5 ms subframes for better tracking of pitch an gain parameters plus reduced codebook search complexity. the second subframe of a frame uses quantized and unquantized LP coefficients while the first subframe uses interpolates LP coefficients. Each subframe has an excitation represented by an adaptive codebook part and a fixed-codebook part: the adaptive-codebook part represents the periodicity in the excitation signal using a fractional pitch lag with resolution of ⅓ sample and the fixed-codebook represents the difference between the synthesized residual and the adaptive-codebook representation.

The G.729 CS-ACELP decoder is represented in the block diagram in FIG. 2. According to the standard, the excitation parameter's indices are extracted and decoded from the bitstream to obtain the coder parameters that correspond to a 10 ms frame of speech. The excitation parameters include the LSP coefficients, the two fractional pitch (adaptive codebook) 26 delays, the two fixed-codebook vectors 28, and the two sets of adaptive codebook gains Gₚ 36 and fixed-codebook gains G_{c} 42. The LSP coefficients are converted to LP filter coefficients for 5 ms subframes. The excitation is constructed by adding 30 the adaptive 26 and fixed-codebook 28 vectors that are scaled by the adaptive 36 and fixed-codebook 42 gains, respectively. The excitation is filtered through the Linear Prediction (LP) synthesis filter 44 in order to reconstruct the speech signals. The reconstructed speech signals are passed through a post-processing stage 48. The post-processing 48 includes filtering through an adaptive post-filter based on the long-term and short-term synthesis filters. This if followed by a high-pass filter and a scaling operation of the signals.

FIG. 3 illustrates a typical packet used to transmit voice payload data in a packet network. Packet 50 generally contains a header section 52 that comprises Internet Protocol (IP) 56, UDP 58 and Real-time Protocol (RTP) address sections. Payload section 54 comprises between one and a variable number of frames of data. Frames 62-70 are shown as frame blocks in the packet 50 that contain voice data. Voice data is transmitted between two endpoints 18 and 24 using packets 50. When a packet is lost in the network 10, the G.729 packet loss concealment (PLC) (also called frame loss concealment or reconstruction) algorithms are used to hide losses by reconstructing the signal from the characteristics of the past signal. These algorithms reduce the click and pops and other artifacts that occur when a network experiences packet loss. PLC was intended to improve the overall voice quality in unreliable networks.

The G.729 method handles frame erasures by providing a method for lost frame reconstruction based on previously received information. Namely, the method replaces the missing excitation signal with an excitation signal of similar characteristics of previous frames while gradually decaying the new signal energy when continuous (e.g., multiple) frame loss occurs. Replacement uses a voice classifier based on the long-term prediction gain, which is computed as part of the long-term post-filter analysis. The long-term post-filter sues the long-term filter with a lag that gives a normalized correlation greater than 0.5. For the error concealment process, a 10 ms frame is declared periodic if at least one 5 ms subframe has a long-term prediction gain of more than 3 dB. Otherwise the frame is declared non-periodic. An erased frame inherits its class from the preceding (reconstructed) speech frame. The voicing classification is continuously updated based on this reconstructed speech signal.

PLC is a feature added to the G.729 decoder in order to improve the quality of decoded and reconstructed speech even when the speech transmission signals suffer packet loss in the bitstream. In the standard, the missing frame must be reconstructed based on previously received speech signals and information. In summary, the method replaces the missing excitation signal with an excitation signal of similar characteristics, while gradually decaying its energy using a voice classifier based on the long-term prediction gain. The steps to conceal packet loss in G.729 are repetition of the synthesis filter parameters, attenuation of adaptive and fixed-codebook gains, attenuation of the memory of the gain predictor, and generation of the replacement excitation.

In G.729 the Adaptive Codebook parameters (pitch parameters) 26 are the delay and gain. In the adaptive-codebook technique using the pitch filter, the excitation is repeated for delays less than the subframe length. The fraction pitch delay search for To_frac and To are calculated using the G.729 techniques 32. Tₒ relates to the periodic fundamental frequency of the period, and the fractional delay search searches near the neighbors of the open loop delay that is used to adjust the optimal delay. After the pitch delay 32 has been found, the adaptive codebook vector 26 v(n) is calculated by interpolating the past excitation signal u(n) at the given integer delay and fraction. Once the adaptive-codebook delay is determined, the adaptive-codebook gain gₚ 36 is calculated as ninety percent of the previous subframe gain gₚ^{(m-1)} bounded by gₚ^{(m)}=min{0.9, 0.9*Gp). For PLC, the adaptive-codebook gain 34 is based on an attenuated version of the previous adaptive-codebook gain at the current frame m.

The fixed codebook 28 in G.729 is searched by minimizing the mean-squared error between the weighted input speech signal in a subframe and the weighted reconstructed speech. The codebook vector c(n) is determined by using a zero vector of dimension 40, and placing four unit pulses i₀ to i₃ at the found locations according to the calculations (38) in G.729. The fixed-codebook gain g_{c} (42) is based on an attenuated version 40 of the previous fixed-codebook gain, given by g_{c}^{(m)}=0.98 g_{c}^{(m-1)} where m is the subframe index.

After combining 30 the attenuated adaptive and fixed codebook parameters, the decoded or reconstructed speech signal is passed through a short-term filter 44 where the received quantized Linear Prediction (LP) inverse filter and scaling factors control the amount of filtering. Input 46 uses the Line Spectral Pairs (LSP) that are based on the previous LSP and the previous frequency is extracted from the LSP. Next, Post-Processing step 48 has three functions, 1) adaptive post-filtering, 2) high-pass filtering, and 3) signal upscaling.

A problem in the use of the G.729 frame erasure reconstruction algorithm, however is that the listener experiences a severe drop in sound quality when speech is synthesized to replace lost speech frames. Further, the prior algorithm cannot properly generate speech to replace speech in lost frames when a noise frame immediately precedes a lost frame. The result is a severely distorted generated speech frame and the distortion carries over in speech patterns following the generated lost frame.

Further, since the G.729 PLC provision is based on previously received speech packets, if a packet loss occurs at the beginning of a stream of speech the G.729 PLC can not correctly synthesize a new packet. In this scenario, the previously received packet information is from silence or noise and there is no way to generate the lost packet to resemble the lost speech. Also, when a voice frame is received after a first lost packet, the smoothing algorithm in G.729 PLC recreates a new packet based on noise parameters instead of speech and then distorts the good speech packet severely due to the smoothing algorithm.

### SUMMARY OF THE INVENTION

The preferred embodiment improves on the existing packet loss concealment recommendations for the CS-ACELP decoder found in the ITU G.729 recommendations for packet networks. To the adaptive pitch gain prediction of the decoder, ad adaptive pitch gain prediction method is applied that uses data from the first good frame after a lost frame. To the fixed codebook gain, a correction parameters prediction and excitation signal level adjustment methods are applied. After combining the adaptive codebook and fixed codebook parameters to determine the excitation signal level, a backward estimation of LSF prediction error may be applied to the short-term filter of the decoder.

The alternative embodiment provides concealment of erased frames for voice transmissions under G.729 standards by classifying waveforms in preceding speech frames based on an adaptive codebook excitation linear prediction analysis (ACELP) bit stream. The classifications are made according to noise, silence, status of voice, on site frame, and the decayed part of the speech. These classifications are analyzed by an algorithm that uses previous speech frames directly from the decoder in order to generate synthesized speech to replace speech from lost frames.

### BRIEF DESCRIPTION OF THE DRAWINGS

For a better understanding of the nature of the present invention, its features and advantages, the subsequent detailed description is presented in connection with accompanying drawings in which:

FIG. 1 illustrates a voice-data network capable of implementing the embodiments;

FIG. 2 is a diagram of a prior art CS-ACELP decoder;

FIG. 3 is an example of a packet format used in packet networks;

FIG. 4 is a diagram of the preferred embodiment for a CS-ACELP decoder;

FIG. 5 is a illustrates a flowchart for defining the pitch gain status;

FIGS. 6A and 6B contain a flowchart that includes a preferred method to determine pitch gain estimation at lost frames in the decoder;

FIG. 7 illustrates a flowchart of the preferred method for excitation signal level adjustment after packet loss;

FIG. 8 illustrates a flowchart determining status of the correction factor γ used to find the predicted gain g′_{c} based on the previous fixed codebook energies;

FIG. 9 illustrates a state machine diagram showing the different states of classification determined by the alternative embodiment;

FIG. 10 shows a flowchart of determining whether the signals in the incoming bitstream indicate silence, noise, or on-site;

FIG. 11 contains a flowchart for determination of whether the signals whose previous class are silence transition to noise, stay as silence, or transition to on-site signals;

FIG. 12 contains a flowchart for determination of signals that were previously classed as noise remain as noise, or transition to on-site or silence;

FIG. 13, a flowchart determining between whether a voice signal is classed as voice or decay;

FIG. 14 contains a flowchart for determination of whether a signal in decay is transitions to noise or on-site states, or stays in decay; and

FIG. 15 illustrates a flowchart to determine whether a signal in on-site state has transitioned to a voice or decay state or remained in an on-site state.

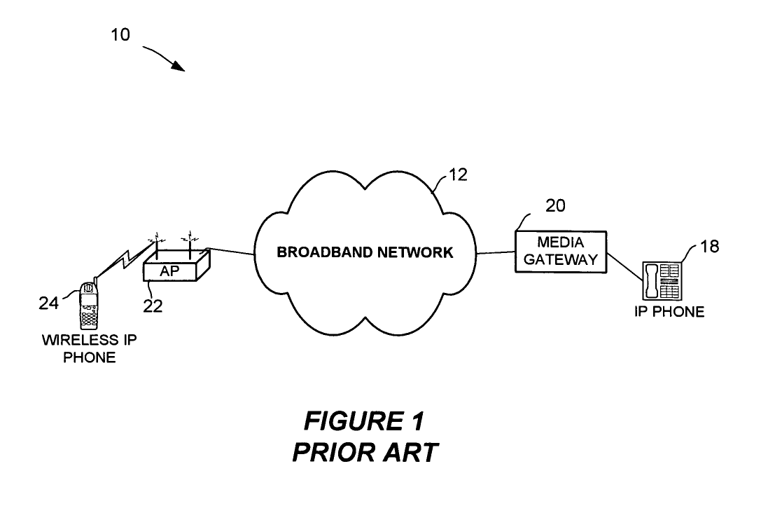

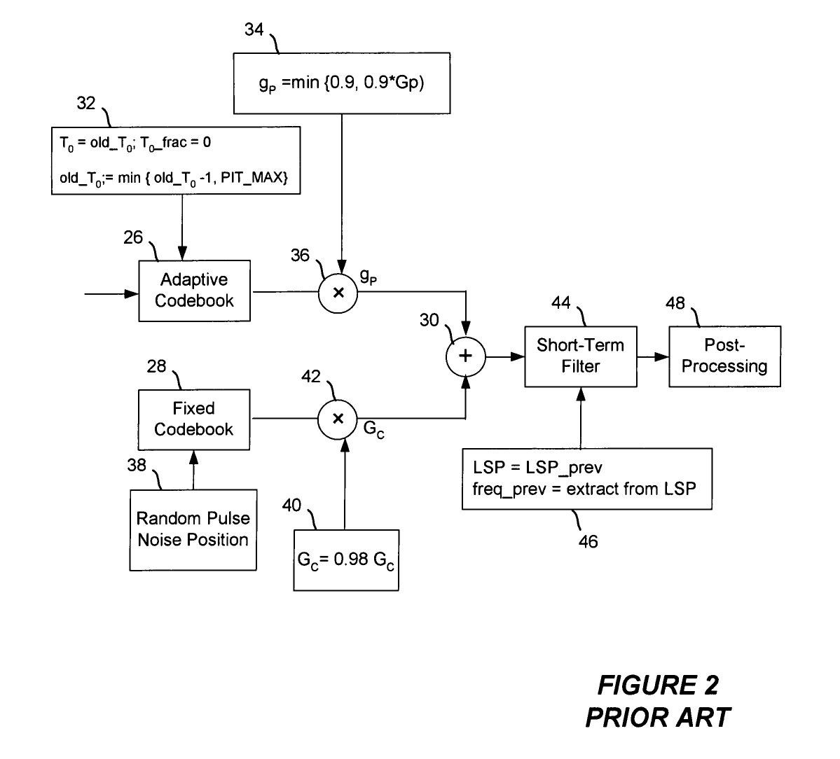

### DETAILED DESCRIPTION OF THE INVENTION

The preferred embodiment improves upon the method for synthesizing speech due to frame erasure according to the International Telecommunication Union (ITU) G.729 methods for speech reconstruction. The preferred embodiment uses an improved decoder to for concealing packet loss due to frame erasure according to the International Telecommunication Union (ITU) G.729 methods for speech reconstruction. The preferred and alternative embodiments can be implemented on any computing device such as an Internet Protocol phone, voice gateway, or personal computer that can receive incoming coded speech signals and has a processor, such as a central processing unit or integrated processor, and memory that is capable of decoding the signals with a decoder.

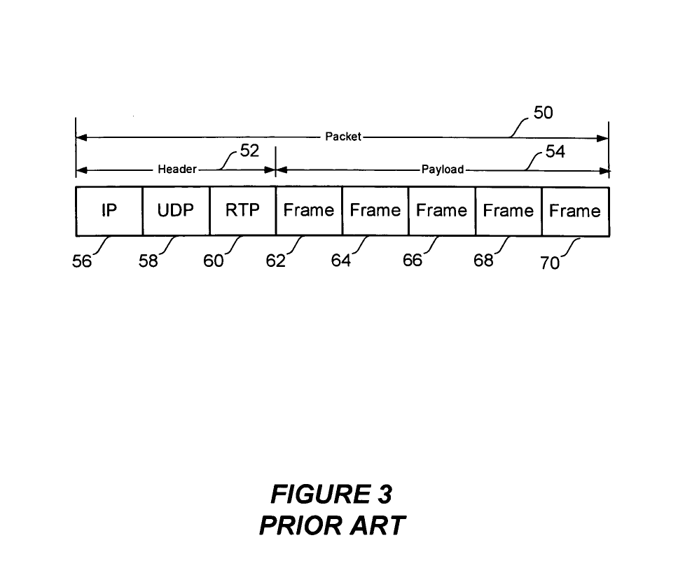

The block diagram in FIG. 3 represents a preferred embodiment of a G.729 speech decoder showing the preferred features added to the decoder in order to improve the decoding packet loss concealment (PLC) functions. Each feature shown in the preferred embodiment may be implemented discreetly, or in other words may be implemented independently of each other preferred feature to improve the quality of the PLC strategy of the decoder. The method uses the first four received subframes in the decoder prior to the first lost frame(s). If time increases from left to right, the sequence of the subframes are −4, −3, −2, −1, and 0, where 0 is the first lost frame. References to a parameter from one of these subframes are designated using “1,” “2,” “3,” or “4” in the subscript of the variable.

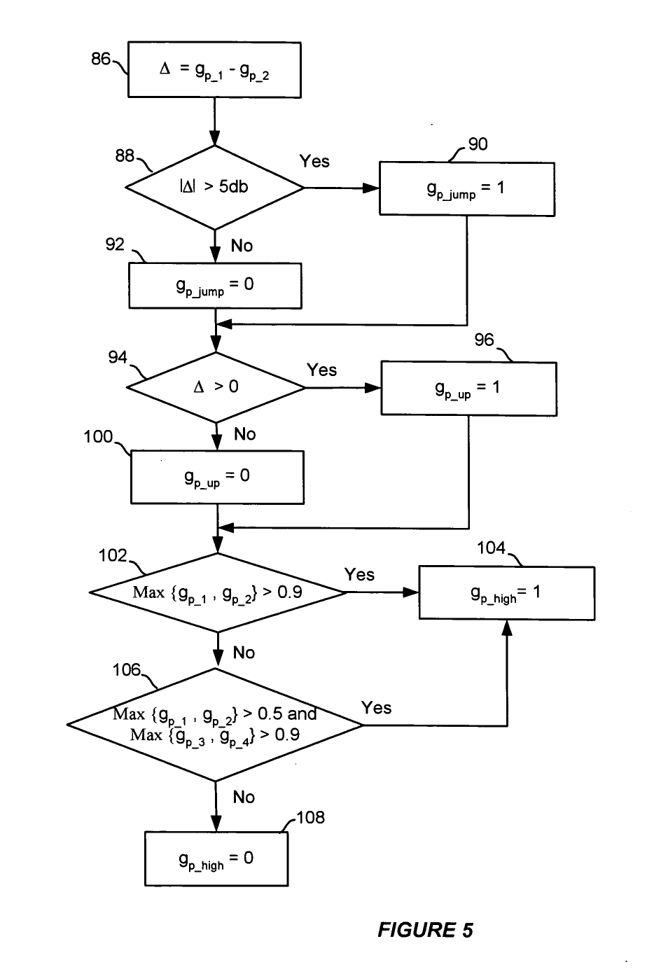

The adaptive-codebook, or pitch, gain prediction 36 is defined by either Adaptive Gain Prediction 72 or Excitation Signal Level Adjustment 74 that are multiplexed 76 into adaptive pitch gain 36. Adaptive pitch gain prediction 72 is a function of the waveform characteristics, the previous pitch gain, the number of lost frames, and the pitch delay T₀ distribution. The flowcharts in FIGS. 5-7 includes the preferred methods to determine the pitch gain status 72. The pitch gain is adjusted in the synthesized frame. Each pitch gain decrease can cause a degradation in performance of the PLC. The pitch gain for the synthesized frame is a function of the current waveform characteristics. The status could be one of jump up, jump down, smoothly increasing, or smoothly decreasing. FIG. 5 illustrates a flowchart for defining the pitch gain status. In the first block 86, the difference Δ between the second subframe pitch gain gₚ_{_{—}}₂ and the first subframe pitch gain gₚ_{_{—}}₁ is determined. If the absolute value of the difference Δ is greater than 5 dBm then the pitch gain jump 90 is equal to 1, otherwise the pitch gain jump 92 is equal to zero.

The method continues to evaluate if the difference is greater than zero 94, then the pitch gain up 96 is equal to 1. If the difference is not greater than zero, then the pitch gain up 100 is equal to zero. The next step 102 determines if the maximum pitch gain of either the first subframe pitch gain or the second subframe pitch gain is greater than 0.9, then the high pitch gain gₚ_{_{—}}_{high} 104 is equal to 1. However if evaluation 102 is not greater than 0.9, the method proceeds to evaluate 106 the maximum of the first and second subframe pitch gains and the third gₚ_{_{—}}₃ subframe pitch gain and the fourth subframe gₚ_{_{—}}₄ pitch gains. If maximum pitch gain of either the first or second subframe pitch gains is greater than 0.5 dBm and if the maximum of either the third or fourth subframe pitch gains is greater than 0.9 dBm, then the high pitch gain 104 is equal to 1, otherwise the high pitch gain 108 is equal to zero.

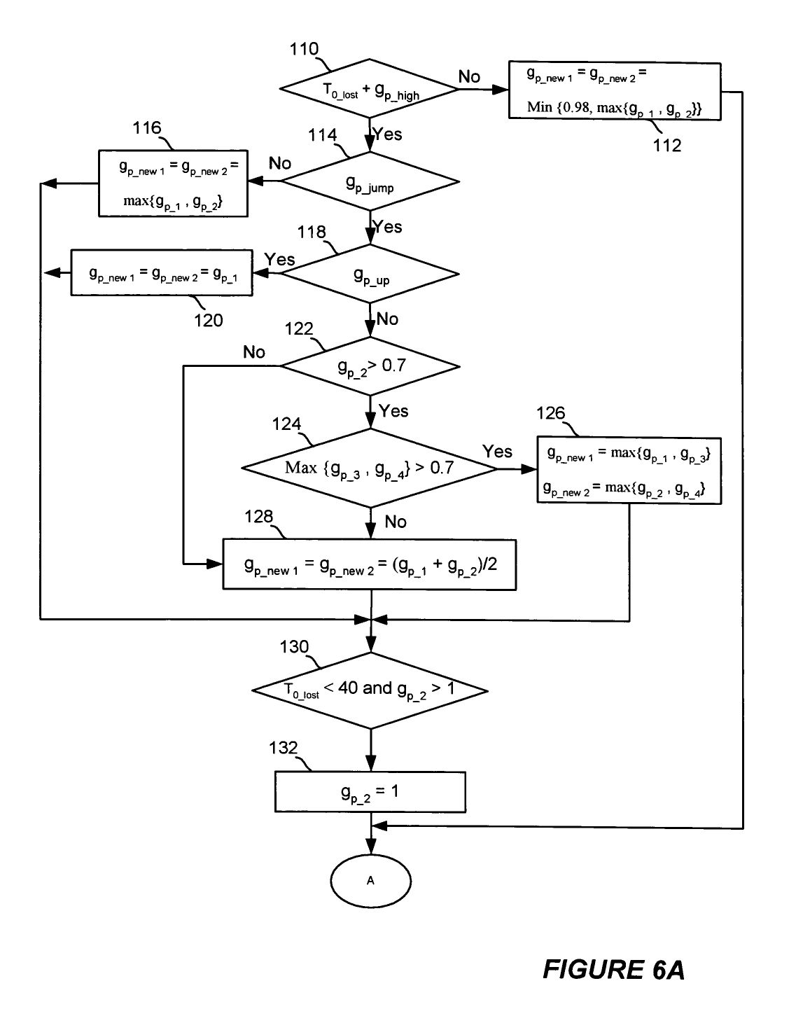

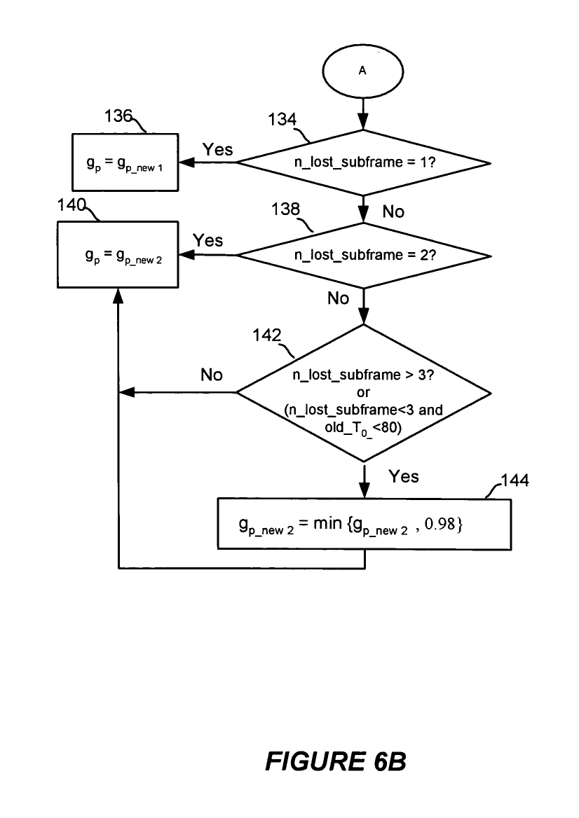

FIGS. 6A and 6B contain a flowchart that includes a preferred method to determine pitch gain 36 estimation at bad (e.g., lost) frames in the decoder at 72. If the pitch delay for the lost frame T₀_{_{—}}ₗₒₛₜ and the high attenuated pitch gain factor gₚ_{_{—}}_{high} are both determined, then a determination of whether to jump the pitch gain gₚ_{_{—}}ⱼᵤₘₚ 114 is made. If the pitch delay for the lost frame and the high attenuated pitch gain factor are not both determined, then in step 112 new (e.g., synthesized) frame first pitch gain gₚ_{_{—}}_{new 1} is equal to the new frame second pitch gain gₚ_{_{—}}_{new 2}, which is also equal to the minimum of either 0.98 or the maximum of either the previous first pitch gain or second pitch gain. In step 114 if the pitch gain at the bad frame is determined to jump, then the determination is made to whether the pitch gain jumps up 118 to gₚ_{_{—}}ᵤₚ. If the pitch gain jumps up 118, then in step 120 the new frame first pitch gain gₚ_{_{—}}_{new 1} is equal to the new frame second pitch gain gₚ_{_{—}}_{new 2}, which are both equal to the received first pitch gain gₚ_{_{—}}₁. If the pitch gain does not jump up 114, then in step 116 new (e.g., synthesized) frame first pitch gain gₚ_{_{—}}_{new 1} is equal to the new frame second pitch gain gₚ_{_{—}}_{new 2}, which is also equal to the maximum of either the previous first pitch gain or second pitch gain. If the pitch gain is not determined to jump up 118, then a decision is made in step 122 whether the second pitch gain is greater than 0.7. If the second pitch gain is not greater than 0.7 then the method moves to box 128 where the new frame first pitch gain gₚ_{_{—}}_{new 1} is equal to the new frame second pitch gain gₚ_{_{—}}_{new 2}, which is also equal to half of the sum of the previous first and second pitch gains. If the second pitch gain is greater than 0.7 in step 122, then a determination is made in 124. If the maximum of either the third or fourth pitch gains is greater than 0.7 then in step 126 the new frame first pitch gain gₚ_{_{—}}_{new 1} is equal to the greater of the maximum of either the first or third pitch gains, and the second pitch gain gₚ_{_{—}}_{new 2} for the new frame is equal to the greater of the maximum of either the second or fourth pitch gains. If the decision in 124 is “no” then the method moves to box 128 to determine the new first and second pitch gains as explained above.

After the pitch gain parameters in steps 116, 120, 126, and 128 are determined, the method determines in 130 that if T₀_{_{—}}ₗₒₛₜ is less than 40 and the second pitch gain factor gₚ_{_{—}}₂ is greater than 1, then in 132 the second pitch gain is set to one. After the method reaches 132, step 112 is also continued to the Flowchart in FIG. 6B. In step 134 if the number of lost subframes nlost_subframe is equal to one, then the attenuated pitch gain pitch gain 36 is equal to the new first pitch gain. If not equal to one in 134, then the method determines in 138 that if the number of lost subframes is equal to two, then the pitch gain is equal to the new second pitch gain in 140. If the not equal to two in step 138, then the decision step 142 determines if one of the number of nlost subframes is greater than three or less than three and the old pitch delay is less than 80, then the pitch gain is found in 140. If one of the conditions in 142 is true, then a new determination of the new second pitch gain gₚ_{_{—}}_{new 2} is found equal to the minimum of either the current gₚ_{_{—}}_{new 2} or 0.98. After this determination 144, the new second pitch gain is used to find the pitch gain gₚ in step 140.

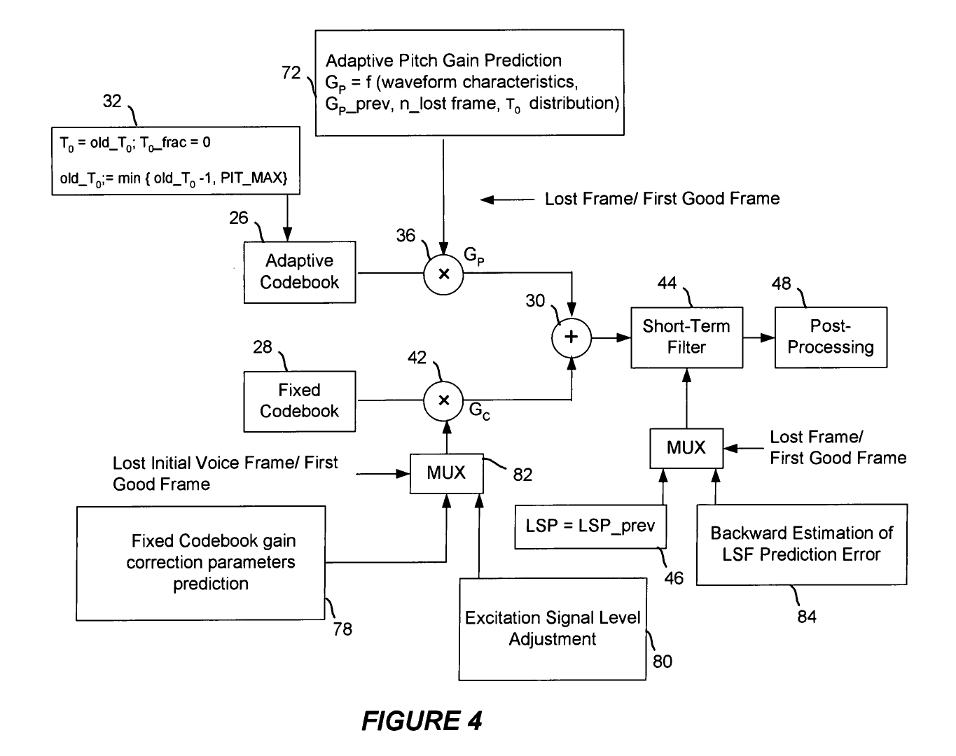

In the preferred decoder of FIG. 4, a preferred method of excitation signal level adjustment 80 after packet loss can be applied to fixed codebook gain 42 of the next good frame through MUX 82. During the packet loss, the pulse positions of fixed codebook 28 are unknown, thus it can be difficult to predict them correctly. Wrong pulse locations within a large gain 42 can cause severe distortion on synthesized signals of lost frames and the contiguous good frames in the rest of speech frames. Therefore, zero fixed codebook gain is used in lost frames, which is the standard recommendation in G.729. To composite the fixed codebook contribution, the beginning of the next good frame will adjust the excitation signal level based on the current codebook gain and lost frame duration. The excitation signal level adjustment is applied to adjust the gain error

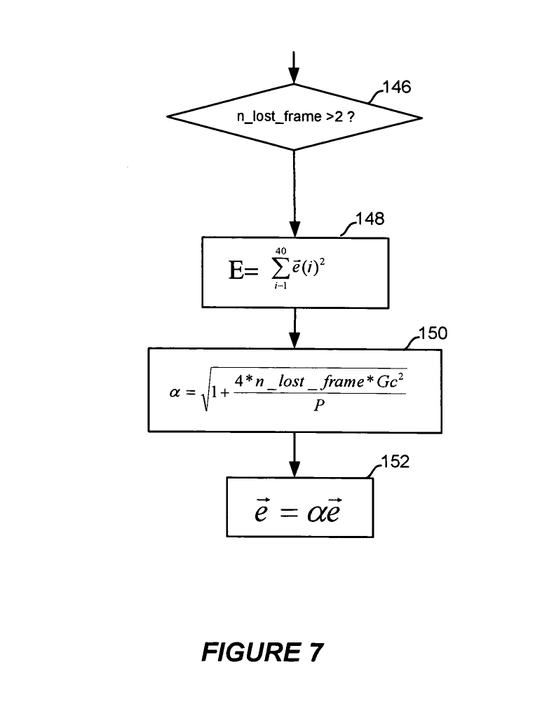

Further preferred embodiments of improving the PLC strategy in decoder of FIG. 4 is the excitation signal level adjustment 80 applied to the fixed codebook 28 gain 42. FIG. 7 illustrates a flowchart of the preferred method for excitation signal level adjustment after packet loss 80 that can be multiplexed 82 into the fixed codebook gain g_{c} 42. In box 146, if the number of lost frames is greater than two, then the mean energy E of the fixed codebook contribution is determined in step 148 for a frame of length fourty. In step 150, the scaling factor is equal to the square root formula in 150. After these are determined, as shown below, the excitation signal level \vec{e} at the first good frame is scaled in step 150 to \vec{e}* α.

At the first good frame, the excitation signal level is \vec{e} and if no packet loss occurs, then the excitation is used in the following calculations to find a scaling factor:

$${{x}^{->}}_{good} = {e}^{->} + {Δ}^{->}$$

$$\begin{matrix}{P}_{good} = \frac{1}{40} {\sum }_{i - 1}^{40} {{x}^{->}}_{good}^{( i )} \\ = \frac{1}{40} {\sum }_{i - 1}^{40} {{e}^{->} ( i )}^{2} + {Δ ( i )}^{2} + 2 {e}^{->} ( i ) Δ ( i )\end{matrix}$$

$$Thus , P = \frac{1}{40} {\sum }_{i - 1}^{40} {e}^{->} ( i ) and E = 40 * P .$$

### Thus the scaling factor α is equal to

$$α = \frac{{P}_{good}}{P}$$

$$where$$

$$\begin{matrix}{P}_{good} \leq \frac{1}{40} {\sum \text{(}}_{i - 1}^{40} {{e}^{->} ( i )}^{2} + {Δ ( i )}^{2} \text{)} \\ = \frac{1}{40} {\sum \text{(}}_{i - 1}^{40} {e ( i )}^{2} \text{)} + 4 K {\sum }_{i - 1}^{K} {g}_{K}^{2} \\ = \frac{1}{40} {\sum \text{(}}_{i - 1}^{40} {e ( i )}^{2} \text{)} + 4 K {\sum }_{i - 1}^{K} {r}_{K}^{2} {G}_{0}^{2} \\ = \frac{1}{40} {\sum \text{(}}_{i - 1}^{40} {e ( i )}^{2} \text{)} + 4 K {G}_{0}^{2} {\sum }_{i - 1}^{K} {r}_{K}^{2}\end{matrix}$$

and the scaling factor is found by

$$α = \sqrt{1 + \frac{4 K {G}_{0}^{2} {\sum }_{i - 1}^{K} {r}_{K}^{2}}{P}}$$

In the gain prediction for the fixed codebook gain g_{c}, the G.729 recommendation defines the fixed codebook gain as g_{c}=γ g′_{c} where g′_{c} is a predicted gain based on the previous fixed codebook energies and γ is a correction factor. The mean energy of the fixed codebook contribution in G.729 is defined as

$$E = 10 log ( \frac{1}{n} {\sum }_{i = 0}^{n} {c ( n )}^{2} )$$

The fixed codebook gain g_{c} can be expressed as

g_{c}=10^{(E}^{^{(m)}}^{+Ē-E)/20)}

where Ē=30 dB is the mean energy of the fixed codebook excitation and E^{(m)} is the mean-removed energy of the scaled fixed codebook contribution at subframe m. E^{(m)} is given as

$${E}^{( m 0} = {U}^{( m )} + {\tilde{E}}^{( m )} = {U}^{( m )} + {\sum }_{i = 1}^{4} {b}_{i} {U}^{( m - i )}$$

where b is the moving average prediction coefficient and U^{(m)} is the prediction error at subframe m. Due to the memory for the PLC, lost packets have impacts on the beginning of good frames. Thus, the prediction error U^{(m)} must be very precise because it must be made on the projection error memory of the fixed codebook gain.

In FIG. 4, improving the fixed codebook gain correction parameters prediction 78 is one of the preferred methods for improving the gain prediction of the fixed codebook gain. This prediction 78 can be contributed to gain 42 through MUX 82 after the at the first good frame after packet loss. At the first good voice frame after a packet loss, U^{(m)} and U^{(m+1)} can be decoded from the following in order to improve the gain prediction of gc.

If the number of lost frames is equal to one (nlost_frames=1), then

U^{(m-1)}=0.5 U^{(m)}+0.5 U^{(m-3)}

U^{(m-2)}=0.5 U^{(m+1)}+0.5 U^{(m-4)}

### If the number of lost frames equals two (nlost_frames=2) then

U^{(m-1)}=0.75 U^{(m)}+0.25 U^{(m-3)}

U^{(m-2)}=0.75 U^{(m+1)}+0.25 U^{(m-4)}

U^{(m-3)}=0.25 U^{(m)}+0.75 U^{(m-3)}

U^{(m-4)}=0.25 U^{(m+1)}+0.75 U^{(m-3)}

### If the number of lost frames is greater than two (nlost_frames>2), then

U^{(m-1)}=U^{(m)}

U^{(m-2)}=U^{(m+1)}

U^{(m-3)}=0.9 U^{(m)}+0.1 U^{(m-3)}

U^{(m-4)}=0.9 U^{(m+1)}+0.1 U^{(m-3)}

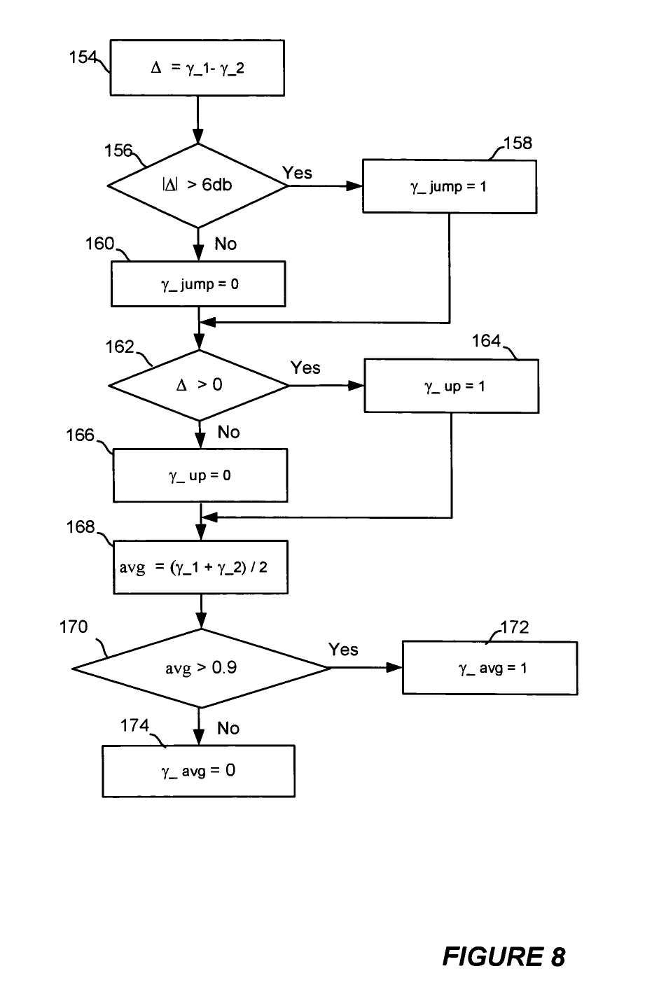

Further preferred methods to improve gain prediction 78 for fixed codebook gain 42 is a determination of prediction error status of fixed codebook gain. FIG. 8 illustrates a flowchart determining status of the correction factor γ used to find the predicted gain g′_{c} based on the previous fixed codebook 28 energies. In step 154 a difference Δ between first correction factor γ_{—}1 and second correction factor γ_{—}2. If the absolute value of difference Δ is greater than 6 dB in step 156, then the correction factor jumps 158 equal to one (γ_{—}=1). Otherwise, the jump 160 is equal to zero. Both options continue in the method to 162 and determine if the difference Δ is greater than zero. If true, ten the correction factor increase 164 is to equal to one and if not true then the correction factor increase 166 equals zero. Both option steps 164 and 166 continue to calculate the average correction factor in 168. If in step 170 the average is greater than 0.9, then the average correction factor equals to one 172. If not greater than 0.9, then the average correction factor is equal to zero 174.

Referring again to the preferred embodiment of FIG. 4, an additional technique to improve the decoder and PLC is the application of backward estimation of LSF prediction error 84 to the short term filter 44. This preferred method 84 can be multiplexed into the short term filter in MUX 85 with the traditional LSP determination 46. Since the voice spectrum slowly varies from one frame to the next frame, the CELP coder uses spectrum parameters of previous frames to predict the current frames. Line Spectrum Frequency (LSF) coefficients are used in the G.729 codec. A switched fourth-order MA prediction is used to predict the LSF coefficients of the current frame

nupdate_frame=min{4, nlost_frame}

The difference between the computed and predicted coefficients is quantized using a two-stage vector quantizer. The first stage is a ten-dimensional VQ using codebook L1. The second stage is a split two five-dimensional VQ using codebooks L2 and L3. The prediction error can be obtained by

$${l}_{i} = \{ \frac{L {1}_{i} ( L 1 ) + L {2}_{i} ( L 2 )}{L {1}_{i} ( L 1 ) + L {3}_{i - 5} ( L 3 )} \frac{i = 1 , … , 5}{i = 6 , … , 10}$$

The current frame LSF is calculated by

$${ϖ}_{i}^{( m )} = ( 1 - {\sum }_{k = 1}^{4} {\hat{p}}_{i , k} ) {l}_{i}^{( m )} + \sum {\hat{p}}_{i , k} {l}_{i}^{( m - k )}$$

where \hat{p}_{i,k} is the MA predictor for the LSF quantizer. When packet loss occurs, the previous sub-frame spectrum will be used to generate lost signals. When the first good frame arrives, the following backward prediction algorithm will be used to generate LSF memory for current LSF. The weighted sum of the previous quantizer outputs is determine with

lᵢ^{(m-k)}αlᵢ^{(m)}+βlᵢ^{(m-nlost}_{^{—}}^{frame)}

where α and β are backwards error parameters in the calculation methods.

The backwards prediction error parameters are determined as follows. For k=1 to nupdate_frame, switch (nlost_frame) according to the following cases:
Case 1: α=0.75; β=0.25
Case 2: If (k=1) then α=0.75; β=0.25
   else α=0.5; β=0.5
Case 3: If (k=1) then α=0.75; β=0.25
   If (k=2) then α=0.5; β=0.5
      else α=0.25; β=0.75
Default: If (k=1) then α=0.9; β=0.1
   If (k=2) then α=0.75; β=0.25
   If (k=3) then α=0.5; β=0.5
      else α=0.25; β=0.75

The method of the alternative embodiment uses data from the decoder bitstream prior to being decoded in order to reconstruct lost speech in PLC due to frame erasures (packet loss) by classifying the waveform. The alternative embodiment is particularly suited for speech synthesis when the first frame of speech is lost and the previously received packet contains noise. When the packet The alternative embodiment for PLC is to use a method of classifying the waveform into five different classes: noise, silence, status speech, on-site (the beginning of the voice signal), and the decayed part of the voice signal. The synthesized speech signal can then be reconstructed based on the bitstream in the decoder. The alternative method derives the primary feature set parameters directly from the bitstream in the decoder and not from the speech feature. This means as long as there is a bitstream in the decoder, then the features for the classification of the lost frame can be obtained.

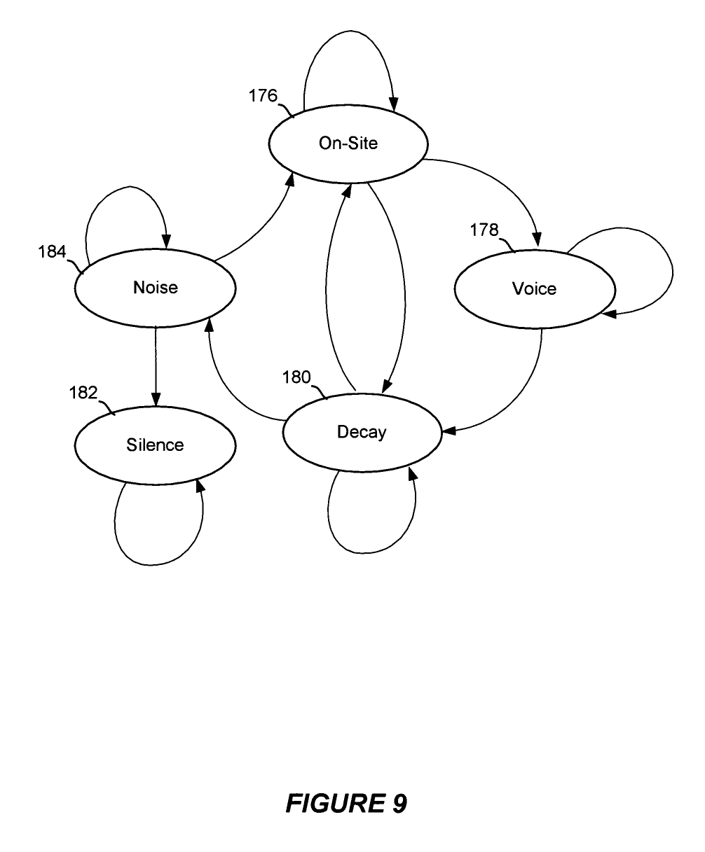

FIG. 9 illustrates a state machine diagram showing the different states of classification determined by the alternative method. The different possible classifications are:

| | |
|---|---|
| 0 | noise |
| 1 | steady voice |
| 2 | on-site |
| 3 | decay |
| 4 | silence |

The on-site state 176 is the state of a beginning of the voice in the bitstream. This state is obviously important in order to determine if the state should transition into voice 178. After voice signals have ended the state transitions to a voice decay 180 state. From decay state 180 the machine begins looking for an additional on-site state again 180 in the bitstream in which voice signals begin or whether the next frame is carrying noise in which the machine transitions into the noise state 184. From noise state 184 the signal could transition either to voice state 178 via on-site 176 if good voice frames are received in the decoder or to silence 182 if the decoder determines that the noise is actually silence in the received frames.

The alternative method uses the following input parameters in its calculations:

| | |
|---|---|
| frame power level in dB | Pᵢ |
| pitch gain | gᵢ |
| fixed coding book gain factor | γᵢ |
| previous classes | cls(i) |

The following thresholds and ranges are used in the calculations of waveform categories and are based on previous power levels:

| | | |
|---|---|---|
| silence threshold | −60 | dBm |
| noise level threshold | −40 | dBm |
| on-site/decay ranges | <−30 | dBm |
| voice range | >−40 | |

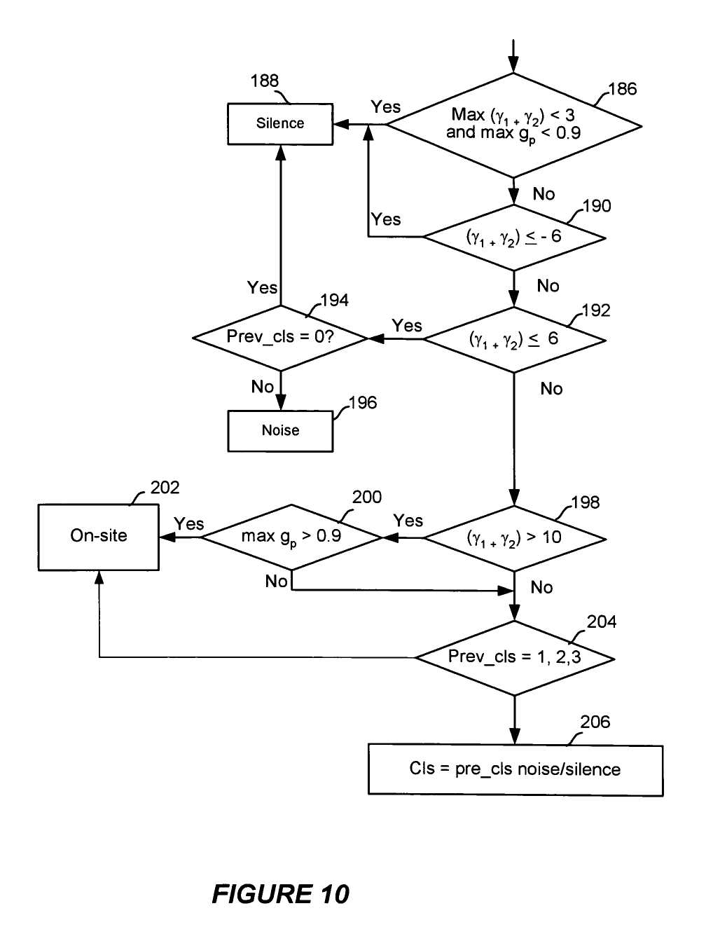

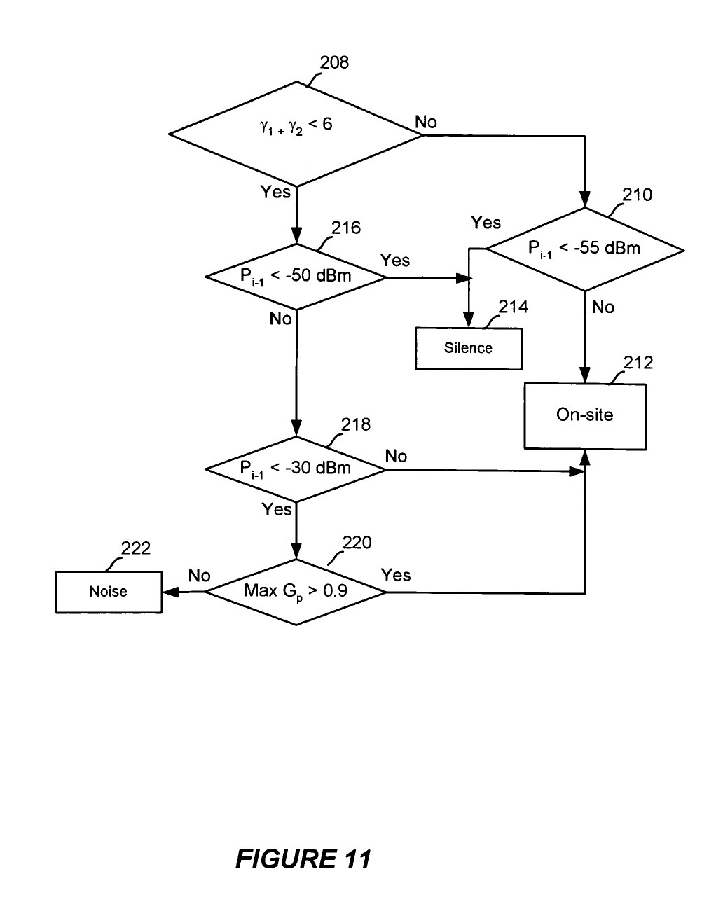

In the first determination of waveform classification, FIG. 10 shows a flowchart of determining whether the signals in the incoming bitstream indicate silence 188, noise 196, or on-site 202. The method assumes that the power level of the previous frame Pᵢ₋₁<−60 dBm, which is necessary for extremely lower level input. In the flowchart, silence is 188 determined in step 186 if the maximum of (γ₁, γ₂)<3 and the maximum gₚ<0.9. In step 190 silence is determined if the sum (γ₁+γ₂)<−6. The signal is also silence if the previous classification was silence 194 and the sum of (γ₁+γ₂)>6 in step 192. Otherwise, the signal is noise 196. In step 198, if the sum of (γ₁+γ₂)>10 and the maximum pitch gain gₚ<0.9 (step 200), then the signal is on-site 202. If the previous classification was classes 1, 2, or 3 and the sum of (γy₁+γ₂)>6, the signal is on-site 202 but otherwise is classified as noise 206. If the sum of (γ₁+γ₂)>−6, then a previous classification of noise or silence 206 is used, otherwise the signal is deemed silence. [0047] FIG. 11 contains a flowchart for further determination of whether the signals whose previous class are silence 182 transition to noise 184, stay as silence 182, or transition to on-site signals 176. In the first case, if (γ₁+γ₂)<6, in step 208, and if the power for the previous frame Pᵢ₋₁<−50 dBm in step 216, then the class is silence 214. In the second case, if (γ₁+γ₂)<6, in step 208, if Pᵢ₋₁<−30 dBm in step 218, and if maximum pitch gain max Gₚ>0.9, then the signal is classified on-site 212. Otherwise, if Pᵢ₋₁ is not less than −30 (step 218) the signal is on-site 212, and if maximum pitch gain max Gₚ is not greater than 0.9 (step 220), then the signal is classified noise 222. In the second case, if (γ₁+γ₂)>6 in step 208, then and Pᵢ₋₁<−55 in step 210, then the signal is classed as silence 214 but would otherwise be classified on-site 212. Here, if Pᵢ₋₁>−60 then the signal would pass on from this evaluation for classification.

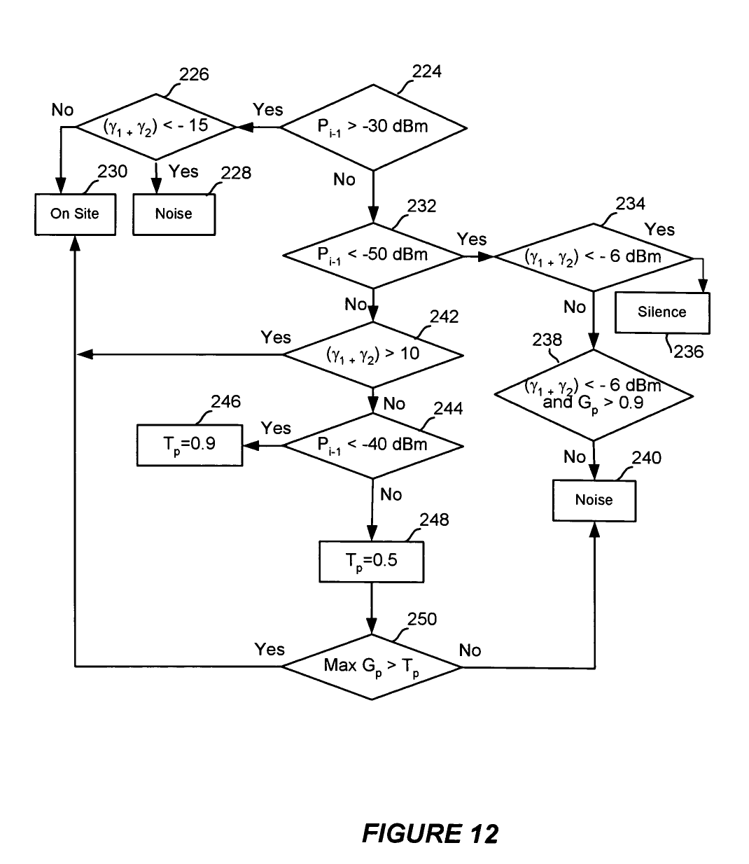

Referring to FIG. 12, four cases are presented to evaluate signals that were previously classed as noise 184 remain as noise 184, or transition to on-site 176 or silence 182. In the first case, if power level Pᵢ₋₁>−30 dBm in step 224 and the sum (γ₁+γ₂)<−15 in 226 then the class is noise 230 but otherwise is on-site 230. In the second case, if Pᵢ₋₁<−50 in step 232 and (γ₁+γ₂)<−6 in step 234 then class is silence 236. However, if (γ₁+γ₂)>10 and maximum pitch gain Gₚ>0.9 in step 238 then the class is on-site 230, otherwise the class is noise 240. Finally, if Pᵢ₋₁>−50 in step 232 and (γ₁+γ₂)>10, the class is on-site 230. In the third case, if Pᵢ₋₁<−40 in step 244 and then the pitch delay Tₚ is 0.9 in 246 but otherwise is 0.5 in 248. From here, if maximum pitch gain Gₚ>Tₚ in 250 the class is onsite 230, otherwise the class is noise 240.

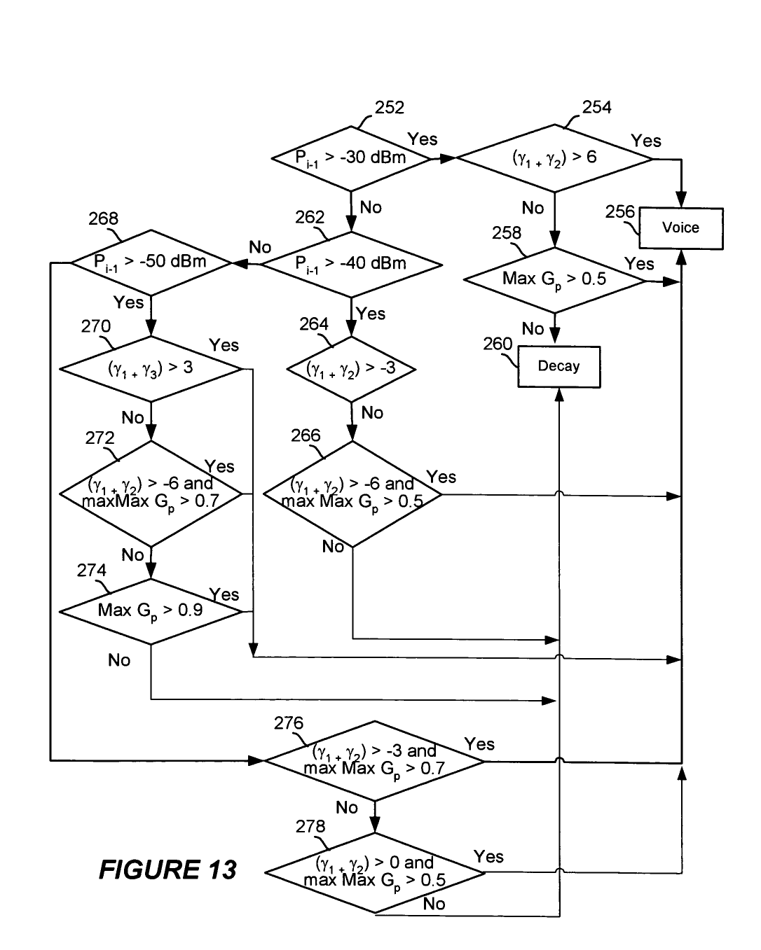

Referring to FIG. 13, a flowchart is shown that includes steps for determining between whether a voice signal 178 is classed as voice 176 or transitions to decay 180. In the first case, if power level Pᵢ₋₁>−30 dBm 252 and (γ₁+γ₂)>−6 in 254 then the class is voice 256. The class also is voice 256 if (γ₁, γ₂)>−6 and maximum pitch gain Gₚ>0.5 in step 253, otherwise the signal is decay 260. In the second case, if Pᵢ₋₁>−40 in 262 and (γ₁+γ₂)>−3 in 264 then the class is voice 256. Here, the class is also voice 256 if (γ₁+γ₂)>−6 and maximum pitch gain Gₚ>0.5, otherwise the class is decay 260. In the third case, if Pᵢ₋₁>−50 dBm in 268 and (γ₁+γ₂)>3 in 270 then the class is voice as well as if (γ₁+γ₂)>−6 while maximum Gₚ>0.7 in 272. However, if in 272 the maximum Gₚ>0.9 then in step 274 the class is voice 256 but otherwise decay 260. In the fourth case, if Pᵢ₋₁<=−50 in 268 and (γ₁+γ₂)>3 while maximum Gₚ>0.7 in 276 or if (γ₁+γ₂)>0 and maximum Gₚ>0.5 then class is voice 256. However, otherwise in 276 and 278 the class is decay 260.

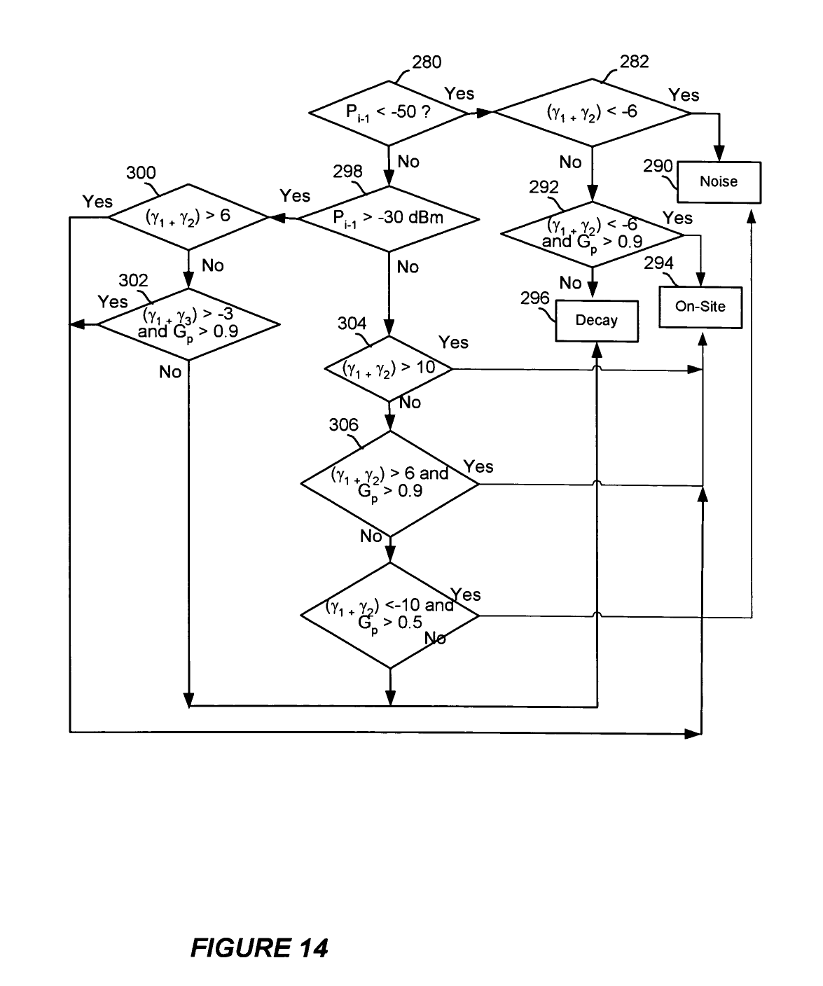

In FIG. 14, a signal in decay 180 is determined to transition to noise 184 or on-site 176 states, or to stay in decay 180 state is determined by the method in the flowchart. In the first case, the class is noise 290 if power level Pᵢ₋₁<−50 in 280 and (γ₁+γ₂)<−−6 in 282. From 282, if (γ₁+γ₂)>10 and maximum Gₚ>0.9 in 282 then the class on site 294, otherwise the class is decay 296. In the second case, if Pᵢ₋₁>−30 in 298 and (γ₁+γ₂)<−6 in 300 then the class is on-site 290, otherwise the class is on-site 294 if (γ₁, γ₂)>−3 and pitch gain Gₚ>0.9 in 302. The alternative to both 300 and 302 is decay class 296. In the third case, if −50≦Pᵢ₋₁≦30 in 280 and 298 and (γ₁+γ₂)>6 in 282 and Gₚ>0.9 in 306 or if (γ₁+γ₂)>10 in 304 then the class is on-site 296. Otherwise if (γ₁+γ₂)<−10 and maximum Gₚ<0.5 in 308 the class is noise 290, else the class is decay 296.

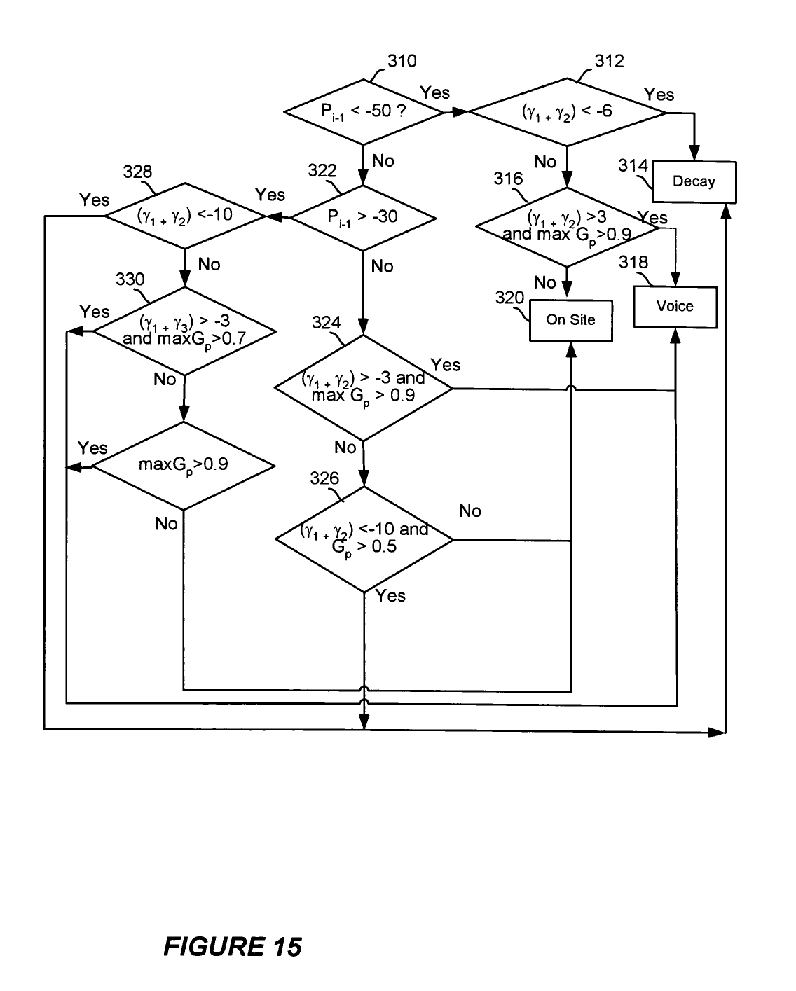

FIG. 15 illustrates a flowchart of the alternative method to determine whether a signal in on-site state 176 has transitioned to a voice 178 or decay 180 state or remained in an on-site 176 state. In the first case, if Pᵢ₋₁<−50 in 310 and (γ₁+γ₂)<−6 in 312 then the class is decay 314. However, if not 312 and (γ₁+γ₂)>3 and maximum pitch gain Gₚ<0.9 in 316 then the class is voice 318, otherwise in 316 the class is on-site 320. In the second case, if Pᵢ₋₁>−30 at 322 and (γ₁+γ₂)<−10 in 328 then the class is decay 324. Otherwise in 328, if (γ₁+γ₂)>3 and maximum Gₚ<0.7 in 330 the class is voice 318 and likewise in 330 if maximum Gₚ<0.9 the class is voice 318. The alternative to 332 is the signal is classed on-site 320. In the third case, if −50≦Pᵢ₋₁≦30 in 310 and 322, (γ₁+γ₂)>−3 and max Gₚ>0.9 in 324, then the class is voice 318. Otherwise, if (γ₁+γ₂)<−10 and max Gₚ<0.5 in 326, then the class is decay 314. The alternative in 326 is that the class is on-site 320.

Since the alternative embodiment evaluates the bitstream prior to being decoded, this method is optimized for conferencing speech where a speaker can be recognized much faster than merely recognizing the speech after it has been decoded. This approach improves the MIPS and memory efficiency of speech encoder/decoder systems. The alternative method gets parameter sets directly from the bit stream and not the speech. Thus, there is no need to decode the speech to select the speaker.

One skilled in the art will appreciate that the present invention can be practiced by other than the described embodiments, which are presented for purposes of illustration and not limitation, and the present invention is limited only by the claims that follow.

What is claimed is:

1. A method for packet loss concealment, comprising:
receiving coded speech signals into an algebraic code excited linear prediction decoder; and
applying an adaptive pitch gain prediction to a pitch gain of an adaptive codebook vector of the signals in the decoder.

2. The method of claim 1, further comprising:
applying a fixed codebook gain correction prediction to a fixed codebook gain of a fixed codebook vector of the signals in the decoder.

3. The method of claim 1, further comprising:
applying an excitation signal level adjustment to a fixed codebook gain of a fixed codebook vector of the signals in the decoder.

4. The method of claim 1, further comprising:
applying a backward estimation of line spectral frequency prediction error to a reconstructed speech signal in a short-term post-processing filter of the decoder.

5. The method of claim 1, wherein the signals are received into the decoder in frames that are divided into subframes, and
the applying the adaptive pitch gain prediction uses subframes of a good frame received in the decoder immediately prior to a lost frame to determine the adaptive pitch gain prediction for a reconstructed frame.

6. The method of claim 2, wherein the signals are received into the decoder in frames that are divided into subframes, and
the applying the fixed codebook gain correction prediction uses subframes of a good frame received in the decoder immediately prior to a lost frame to determine the fixed codebook gain correction prediction for a good frame received immediately after the lost frame.

7. The method of claim 3, wherein the signals are received into the decoder in frames that are divided into subframes, and
the applying an excitation signal level adjustment uses subframes of a good frame received in the decoder immediately prior to a lost frame to determine the excitation signal level adjustment for a good frame received immediately after the lost frame.

8. The method of claim 1, wherein the decoder is an ACELP decoder used in ITU Recommendation G.729 standards.

9. A method for packet loss concealment in a decoder, comprising:
receiving incoming coded speech signals into an algebraic code excited linear prediction decoder; and
classifying states of the signals prior to decoding the signals in the decoder.

10. The method of claim 9, wherein the classifying the states comprises classifying the states according to one of a power level, pitch gain, fixed coding book gain factor, and previous classification of the signals.

11. The method of claim 9, wherein the classifying comprises classifying the signals as a silence state.

12. The method of claim 9, wherein the classifying comprises classifying the signals as a noise state.

13. The method of claim 9, wherein the classifying comprises classifying the signals as an on-site state.

14. The method of claim 9, wherein the classifying comprises classifying the signals as an decay state.

15. The method of claim 9, further comprising:
determining whether the signals classified as one of the states has transitioned into a different state.
